(19) United States
(12) Patent Application Publication
(10) Pub. No.: US 2026/0211284 A1
(43) Pub. Date: Jul. 23, 2026

(54) DISPLAY APPARATUS HAVING A BACK-LIGHT UNIT

(71) Applicant: LG Display Co., Ltd., Seoul (KR)

(72) Inventors: Young Woong KIM, Paju-si (KR); Yong Hun JEONG, Paju-si (KR); Dong Hyeok KIM, Paju-si (KR)

(73) Assignee: LG Display Co., Ltd., Seoul (KR)

(21) Appl. No.: 19/429,713

(22) Filed: Dec. 22, 2025

(30) Foreign Application Priority Data
Jan. 23, 2025 (KR) 10-2025-0010175

(51) Int. Cl. G02F 1/1335; G02F 1/13357

(52) U.S. Cl. CPC G02F 1/133614; G02F 1/133602

(57) ABSTRACT

A display apparatus including a back-light unit is provided. The back-light unit includes light-source devices and a color conversion sheet. The color conversion sheet includes a first conversion substrate on the light-source devices, a conversion sheet layer on the first conversion substrate, light-emitting bodies dispersed within the conversion sheet layer, and a second conversion substrate on the conversion sheet layer. SBR patterns are disposed side by side on at least one surface of the second conversion substrate to selectively reflect short-wavelength blue light. A display panel is disposed on the second conversion substrate. Through this configuration, the ratio of short-wavelength blue light in the light supplied to the display panel is reduced, while the efficiency of color conversion and overall luminance are maintained, thereby providing improved optical performance and reduced blue-light emission from the display apparatus.

### CROSS-REFERENCE TO RELATED APPLICATIONS

This application claims the benefit of Korean Patent Application No. 10-2025-0010175, filed on Jan. 23, 2025, which is hereby incorporated by reference as if fully set forth herein.

### BACKGROUND

### Technical Field

The present disclosure relates to a display apparatus capable to generate image using light emitted from the back-light unit.

### Description of the Related Art

Generally, a display apparatus provides an image to a user. For example, the display apparatus can include a liquid crystal panel on a back-light unit. The back-light unit can provide light displaying a specific color to the liquid crystal panel. For example, the back-light unit can provide white light to the liquid crystal panel. The liquid crystal panel can generate the image using light provided to the back-light unit.

### BRIEF SUMMARY

The present disclosure relates to a display apparatus that includes a color conversion sheet configured to reduce emission of short wavelength blue light while maintaining brightness and color quality. The color conversion sheet includes SBR (short-wavelength blue light reflective) patterns that selectively reflect short wavelength blue light while allowing other wavelengths to pass. These patterns are designed with specific optical and structural relationships to the surrounding substrate to control light transmission and reflection. As a result, the amount of blue light directed toward the user is reduced, and the efficiency of red and green light generation within the color conversion layer is improved.

The color conversion sheet includes a conversion layer positioned between two transparent substrates containing red and green light emitting bodies. The SBR patterns are formed on or within the second substrate, or alternatively, the same optical function is achieved by forming fine concave and convex surface features on the substrate. This configuration allows for precise management of light reflection and transmission while simplifying manufacturing and maintaining optical performance.

A blue emission sheet may also be provided to evenly diffuse the light from the blue light source devices, ensuring uniform color mixing and consistent luminance. Through this arrangement, the display apparatus reduces high energy blue light exposure to the viewer, enhances color conversion efficiency, and supports efficient operation with reduced power consumption.

Accordingly, the present disclosure is directed to a display apparatus that substantially obviates one or more problems due to limitations and disadvantages of the related art.

Various embodiments of the present disclosure provide a display apparatus capable of reducing a ratio of the short-wavelength blue light from the light provided to the display panel from the back-light unit.

Various embodiments of the present disclosure provide a display apparatus capable of increasing efficiency of the color conversion sheet.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the present disclosure, as embodied and broadly described herein, there is provided a display apparatus comprising a light-source unit. The light-source unit includes light-source devices. A display panel is disposed on the light-source devices of the light-source unit. A color conversion sheet is disposed between the light-source devices and the display panel. The color conversion sheet includes a first conversion substrate, a second conversion substrate, a conversion sheet layer, light-emitting bodies and SBR patterns. The conversion sheet layer is disposed between the first conversion substrate and the second conversion substrate. The light-emitting bodies are dispersed within the conversion sheet layer. The second conversion substrate is disposed between the conversion sheet layer and the display panel. The SBR patterns are disposed side by side on at least one of the lower surface and the upper surface of the second conversion substrate.

A thickness of each of the SBR patterns can be 750 nm to 800 nm.

The SBR patterns can be in direct contact with the second conversion substrate.

The SBR patterns being in contact with the second conversion substrate can be surrounded by the conversion sheet layer.

The SBR patterns can include a different material from the second conversion substrate.

A refractive index of each of the SBR patterns can be at least 0.27 greater than a refractive index of the second conversion substrate.

A width of each of the SBR patterns can be smaller than a distance between adjacent SBR patterns.

An area occupied by the SBR patterns can be 19% to 21% of the total area of the lower surface or the upper surface of the second conversion substrate.

Each of the light-source devices can emit blue light toward the display panel. The light-emitting bodies can include red light-emitting bodies and green light-emitting bodies. Each of the red light-emitting bodies can emit red light in all direction using blue light. Each of the green light-emitting bodies can emit green light in all direction using blue light.

Blue light-emitting bodies can be disposed between the light-source devices and the color conversion sheet. Each of the blue light-emitting bodies can diffuse blue light emitted from each light-source device in all direction.

In another embodiment, there is provided a display apparatus comprising a light-source unit. The light-source unit includes light-source devices. A color conversion sheet is disposed on the light-source devices. The color conversion sheet includes a first conversion substrate, a second conversion substrate, a conversion sheet layer and light-emitting bodies. The conversion sheet is disposed between the first conversion substrate and the second conversion substrate. The light-emitting bodies are disposed within the conversion sheet layer. A display panel is disposed on the second conversion substrate of the color conversion sheet. At least one of the lower surface and the upper surface of the second conversion substrate has an uneven shape by concave regions and convex regions.

A thickness difference between each concave region and each convex region can be 750 nm to 800 nm.

A thickness of each convex region can be smaller than a thickness of each concave region.

An area ratio of the concave regions and the convex regions can be 81:19 to 79:21.

Each of the upper surface and the lower surface of the second conversion substrate can have an uneven shape. An uneven shape of the upper surface can be symmetric to an uneven shape of the lower surface with respect to the center of the second conversion substrate.

### BRIEF DESCRIPTION OF THE SEVERAL VIEWS OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a view schematically showing a display apparatus according to an embodiment of the present disclosure;

FIG. 2 is a view taken along I-I′ of FIG. 1;

FIG. 3 is an enlarged view of K region in FIG. 2; and

FIGS. 4 to 10 are views showing the display apparatus according to another embodiment of the present disclosure.

### DETAILED DESCRIPTION

Hereinafter, details related to the above objects, technical configurations, and operational effects of the embodiments of the present disclosure will be clearly understood by the following detailed description with reference to the drawings, which illustrate some embodiments of the present disclosure. Here, the embodiments of the present disclosure are provided in order to allow the technical sprit of the present disclosure to be satisfactorily transferred to those skilled in the art, and thus the present disclosure may be embodied in other forms and is not limited to the embodiments described below.

In addition, the same or extremely similar elements may be designated by the same reference numerals throughout the specification and in the drawings, the lengths and thickness of layers and regions may be exaggerated for convenience. It will be understood that, when a first element is referred to as being “on” a second element, although the first element may be disposed on the second element so as to come into contact with the second element, a third element may be interposed between the first element and the second element.

Here, terms such as, for example, “first” and “second” may be used to distinguish any one element with another element. However, the first element and the second element may be arbitrary named according to the convenience of those skilled in the art without departing the technical sprit of the present disclosure.

As used herein, the term “connected” is intended to have the broadest possible meaning. Specifically, the phrase “A is connected to B” encompasses both a direct connection—where no intervening components or elements are present- and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and “in contact” should be interpreted in the same manner.

The terms used in the specification of the present disclosure are merely used in order to describe particular embodiments, and are not intended to limit the scope of the present disclosure. For example, an element described in the singular form is intended to include a plurality of elements unless the context clearly indicates otherwise. In addition, in the specification of the present disclosure, it will be further understood that the terms “comprises” and “includes” specify the presence of stated features, integers, steps, operations, elements, components, and/or combinations thereof, but do not preclude the presence or addition of one or more other features, integers, steps, operations, elements, components, and/or combinations.

And, unless ‘directly’ is used, the terms “connected” and “coupled” may include that two components are “connected” or “coupled” through one or more other components located between the two components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

### Embodiment

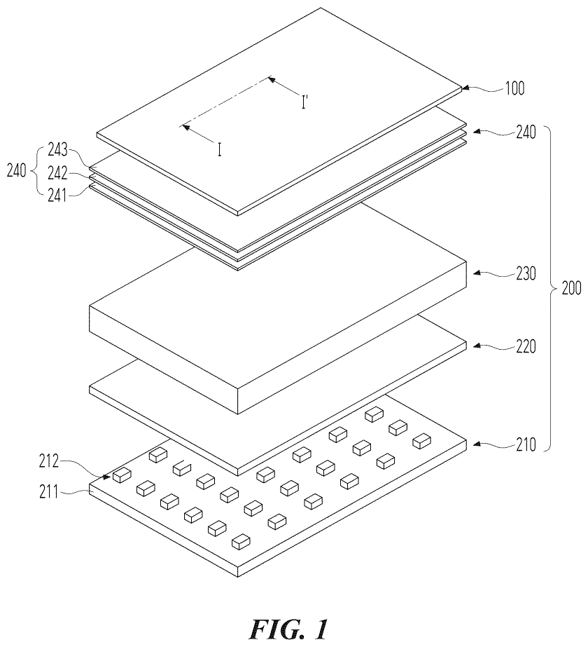

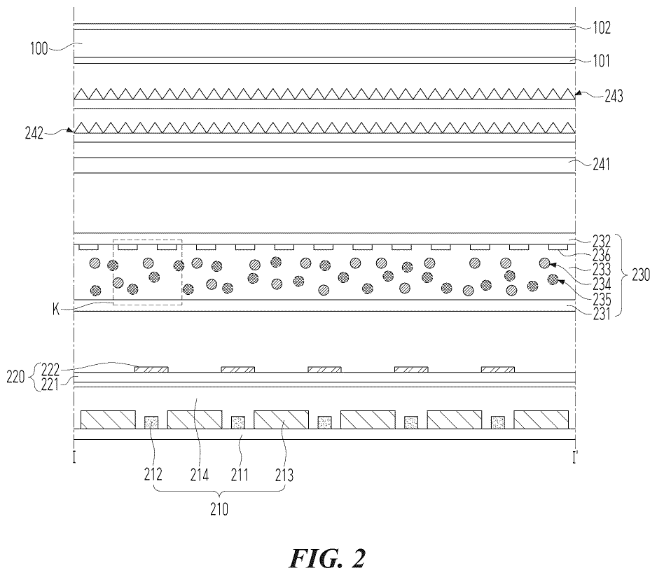

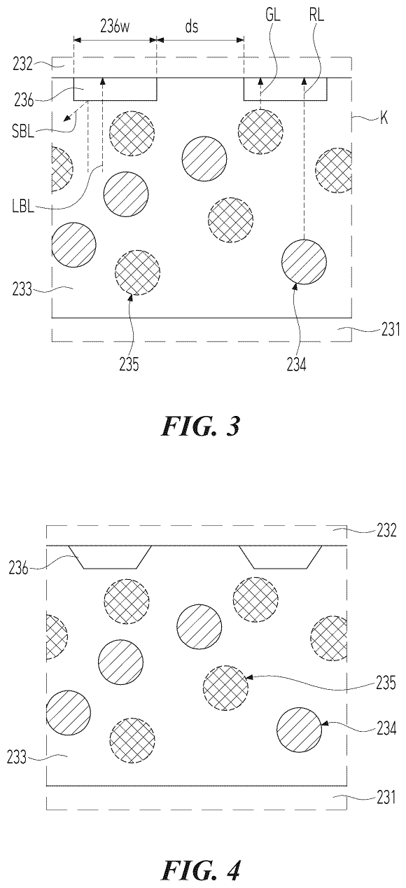

FIG. 1 is a view schematically showing a display apparatus according to an embodiment of the present disclosure. FIG. 2 is a view taken along I-I′ of FIG. 1. FIG. 3 is an enlarged view of K region in FIG. 2.

Referring to FIGS. 1 to 3, the display apparatus according to the embodiment of the present disclosure can include a display panel 100 and a back-light unit 200. The back-light unit 200 can provide light displaying a specific color to the display panel 100. For example, the light provided to the display panel 100 from the back-light unit 200 can be white light. The display panel 100 can generate an image provided to a user using the light provided from the back-light unit 200. For example, the display panel 100 can be a liquid crystal panel including a liquid crystal layer.

The display panel 100 can be disposed between a first linear polarizer 101 and a second linear polarizer 102. At least one of the first linear polarizer 101 and the second linear polarizer 102 can be in direct contact with the display panel 100. For example, a lower surface of the display panel 100 toward the back-light unit 200 can be in direct contact with the first linear polarizer 101, and the second linear polarizer 102 can be in direct contact with an upper surface of the display panel 100 opposite to the lower surface of the display panel 100. A transmission axis of the second linear polarizer 102 can be perpendicular to a transmission axis of the first linear polarizer 101.

The back-light unit 200 can include a light-source unit 210 for providing light. For example, the light-source unit 210 can include a light-source substrate 211 and light-source devices 212.

The light-source substrate 211 can include various signal lines to control the light-source devices 212. For example, the light-source substrate 211 can be a printed circuit board (PCB) in which signal lines are formed.

Each of the light-source devices 212 can emit light displaying a specific color. For example, each of the light-source devices 212 can include a light emitting diode (LED). The light emitted from each light-source device 212 can display a different color from the light provided to the display panel 100. For example, the light emitted from each light-source device 212 can be blue light.

Each of the light-source devices 212 can emit toward the display panel 100. For example, the light-source substrate 211 can be disposed parallel to the lower surface of the display panel 100, and the light-source devices 212 can be mounted side by side on an upper surface of the light-source substrate 211 toward the display panel 100.

A light-blocking sheet 220 can be disposed between the light-source unit 210 and the display panel 100. The light-blocking sheet 220 can include a light-blocking substrate 221 and light-blocking patterns 222. The light-blocking substrate 221 can include a material having a high transmittance. For example, the light-blocking substrate 221 can include plastic. The light-blocking substrate 221 can be disposed parallel to the light-source substrate 211. The light-blocking patterns 222 can be supported by the light-blocking substrate 221. For example, the light-blocking patterns 222 can be disposed side by side on an upper surface of the light-blocking substrate 221 toward the display panel 100. The light-blocking substrate 221 can be disposed between the light-source devices 212 and the light-blocking patterns 222.

The light-blocking patterns 222 can include a material having a high reflectance. For example, the light-blocking patterns 222 can include a metal. The light-blocking patterns 222 can overlap with the light-source devices 212. Thus, in the display apparatus according to the embodiment of the present disclosure, at least some of the light emitted from each light-source device 212 can be reflected toward adjacent light-source device 212 by one of the light-blocking patterns 222 of the light-blocking sheet 220.

The light-source unit 210 can include reflective patterns 213 disposed between the light-source devices 212. Thus, in the display apparatus according to the embodiment of the present disclosure, the light reflected by each light-blocking pattern 222 can be reflected toward the light-blocking substrate 221 by one of the reflective patterns 213. For example, in the display apparatus according to the embodiment of the present disclosure, at least some of the light reflected by each reflective pattern 213 can pass between the light-blocking patterns 222. Therefore, in the display apparatus according to the embodiment of the present disclosure, the light emitted from each light-source device 212 can be diffused into regions disposed between adjacent light-source devices 212 by the light-blocking patterns 222.

At least some of the light emitted from each light-source device 212 can pass through the light-blocking pattern 222 overlapping with the corresponding light-source device 212. Each of the light-blocking patterns 222 can include at least one hole. Thus, in the display apparatus according to the embodiment of the present disclosure, the light emitted from the light-source devices 212 can have a uniform luminance as a whole. For example, in the display apparatus according to the embodiment of the present disclosure, a luminance difference between a region in which each light-source device 212 is disposed and a region disposed between the light-source devices 212 can be reduced. Therefore, in the display apparatus according to the embodiment of the present disclosure, the occurrence of stains due to the arrangement of the light-source devices 212 can be prevented.

The light-source unit 210 can include a light-source planarization layer 214 for preventing the damage of the light-source devices 212 and the reflective patterns 213 due to external impact. The light-source planarization layer 214 can be disposed on the light-source devices 212 and the reflective patterns 213. For example, the light-source devices 212 and the reflective patterns 213 can be completely covered by the light-source planarization layer 214. The light-source planarization layer 214 can be in direct contact with the light-source substrate 211 between the light-source devices 212 and the reflective patterns 213.

The light-source planarization layer 214 can include a material having a high transmittance. The light-source planarization layer 214 can include an adhesive material. For example, the light-source planarization layer 214 can include a curable resin. Thus, in the display apparatus according to the embodiment of the present disclosure, the light-source devices 212 and the reflective patterns 213 can be fixed by the light-source planarization layer 214. Therefore, in the display apparatus according to the embodiment of the present disclosure, the movement of the light-source devices 212 and the reflective patterns 213 due to external impact can be prevented.

The light-blocking substrate 221 can be spaced apart from the light-source planarization layer 214. For example, an air-gap can be disposed between the light-source planarization layer 214 and the light-blocking substrate 211. Thus, in the display apparatus according to the embodiment of the present disclosure, the damage of the light-source devices 212 and the reflective patterns 213 due to the movement of the light-blocking sheet 220 can be prevented.

A color conversion sheet 230 can be disposed between the light-blocking sheet 220 and the display panel 100. The color conversion sheet 230 can include a conversion sheet layer 233 disposed between a first conversion substrate 231 and a second conversion substrate 232 and light-emitting bodies 234 and 235 disposed within the conversion sheet layer 233.

The first conversion substrate 231 and the second conversion substrate 232 can be disposed parallel to the light-blocking substrate 221. The first conversion substrate 231 and the second conversion substrate 232 can include a material having a high transmittance. For example, the first conversion substrate 231 and the second conversion substrate 232 can include plastic. The external impact applied to the conversion sheet layer 233 can be mitigated by the first conversion substrate 231 and/or the second conversion substrate 232. Thus, in the display apparatus according to the embodiment of the present disclosure, deformation of the color conversion sheet 230 due to the external impact can be prevented. The second conversion substrate 232 can include a same material as the first conversion substrate 231.

The conversion sheet layer 233 can include a material having a high transmittance. For example, the conversion sheet layer 233 can include a transparent resin. Each of the light-emitting bodies 234 and 235 can be surrounded by the conversion sheet layer 233. Each of the light-emitting bodies 234 and 235 can emit light displaying a specific color in all direction using the light emitted from the light-source devices 212. The light emitted from each light-emitting body 234 and 235 can display a different color from the light emitted from each light-source device 212. For example, the light-emitting bodies 234 and 235 can include red light-emitting bodies 234 emitting red light in all direction using blue light and green light-emitting bodies 235 emitting green light in all direction using blue light. The red light-emitting bodies 234 and the green light-emitting bodies 235 can be mixed and dispersed within the conversion sheet layer 233. Thus, in the display apparatus according to the embodiment of the present disclosure, the white light provided to the display panel 100 through the color conversion sheet 230 can be formed by mixing the red light emitted from each red light-emitting body 234, the green light emitted from each green light-emitting body 235, and the blue light that is not absorbed by the red light-emitting bodies 234 and the green light-emitting bodies 235.

The color conversion sheet 230 can include SBR patterns 236 disposed side by side on a lower surface of the second conversion substrate 232 toward the conversion sheet layer 233. For example, the SBR patterns 236 can be surrounded by the conversion sheet layer 233. Each of the SBR patterns 236 can be in direct contact with the lower surface of the second conversion substrate 232. For example, the conversion sheet layer 233 can be in direct contact with the lower surface of the second conversion substrate 232 between the SBR patterns 236. Thus, in the display apparatus according to the embodiment of the present disclosure, the movement of the SBR patterns 236 due to the external impact can be prevented by the conversion sheet layer 233. And, in the display apparatus according to the embodiment of the present disclosure, deformation of the SBR patterns 236 due to the external impact can be prevented by the second conversion substrate 232.

The SBR patterns 236 can include a transparent material. For example, the SBR patterns 236 can include plastic. The SBR patterns 236 can include a different material from the second conversion substrate 232.

TABLE 1 is a table showing a ratio of short-wavelength blue light from the light passing through each SBR pattern 236, the color gamut of the light passing through each SBR pattern 236, and the relative luminance of the light passing through each SBR pattern 236 according to a thickness of the corresponding SBR pattern 236. Here, the short-wavelength blue light means blue light having a wavelength range of 400 nm to 455 nm.

TABLE 1

| Thickness of | Ratio of short- | Color | Relative |
|---|---|---|---|
| SBR pattern | wavelength blue | Gamut | luminance |
| (nm) | light (%) | (%) | (%) |
| 600 | 23.20 | 98.90 | 98.70 |
| 650 | 21.50 | 98.80 | 98.30 |
| 700 | 20.10 | 98.40 | 98.20 |
| 750 | 18.30 | 98.00 | 98.00 |
| 800 | 17.20 | 97.80 | 97.40 |
| 850 | 16.30 | 96.30 | 97.00 |
| 900 | 15.40 | 95.00 | 96.80 |

Referring to TABLE 1, as a thickness of each SBR pattern 236 increases, a ratio of short-wavelength blue light from the light passing through the corresponding SBR pattern 236 decreases. That is, in the display apparatus according to the embodiment of the present disclosure, the red light RL emitted from each red light-emitting body 234, the green light GL emitted from each green light-emitting body 235, and long-wavelength blue light that is not absorbed by the red light-emitting bodies 234 and the green light-emitting bodies 235 can pass through the SBR patterns 236, and at least some of the short-wavelength blue light that is not absorbed by the red light-emitting bodies 234 and the green light-emitting bodies 235 can be reflected inside the conversion sheet layer 233 by the SBR patterns 236. That is, in the display apparatus according to the embodiment of the present disclosure, a ratio of short-wavelength blue light from the white light provided to the display panel 100 through the color conversion sheet 230 can be reduced. In general, the short-wavelength blue light with a wavelength range of 400 nm to 455 nm is known to have a negative effect on the human body by relatively high energy. For example, people who are exposed to short-wavelength blue light for a long time can experience impaired vision. Thus, in the display apparatus according to the embodiment of the present disclosure, harmfulness of the image realized by the display panel 100 can be reduced.

Referring to TABLE 1, if a thickness of each SBR pattern 236 is 750 nm or more, a ratio of short-wavelength blue light from the light passing through the corresponding SBR pattern 236 can be reduced, relatively little. And, referring to TABLE 1, if a thickness of each SBR pattern 236 is 800 nm or more, the color gamut and the luminance of the light passing through the corresponding SBR pattern 236 can be relatively significantly reduced. Thus, in the display apparatus according to the embodiment of the present disclosure, each of the SBR patterns 236 can have a thickness of 750 nm to 800 nm. Therefore, in the display apparatus according to the embodiment of the present disclosure, a decrease in the luminance and the color gamut of the white light provided to the display panel 100 due to the SBR pattern 236 can be minimized.

The light reflected by the SBR patterns 236 can be absorbed by the red light-emitting bodies 234 and/or the green light-emitting bodies 235. For example, in the display apparatus according to the embodiment of the present disclosure, at least some of short-wavelength blue light reflected by the SBR patterns 236 can be converted into red light by the red light-emitting bodies 234, and at least some of short-wavelength blue light reflected by the SBR patterns 236 can be converted into green light by the green light-emitting bodies 235. Thus, in the display apparatus according to the embodiment of the present disclosure, efficiency of the color conversion sheet 230 can be improved. The reduced luminance of the white light due to the SBR patterns 236 can be offset by the increased efficiency of the color conversion sheet 230. For example, in the display apparatus according to the embodiment of the present disclosure, the luminance of the white light provided to the display panel 100 can be increased. Therefore, in the display apparatus according to the embodiment of the present disclosure, low-power operation can be possible, and power consumption can be reduced.

At least one optical sheet 240 can be disposed between the color conversion sheet 230 and the display panel 100. The at least one optical sheet 240 can be disposed parallel to the conversion sheet layer 233. For example, the white light formed by the color conversion sheet 230 can be provided to the entire area of the display panel 100 by the at least one optical sheet 240. For example, the at least one optical sheet 240 can have a stacked structure of a diffusion sheet 241, a first prism sheet 242 and a second prism sheet 243.

Accordingly, the display apparatus according to the embodiment of the present disclosure can comprise the back-light unit 200 providing the light to the display panel 100, wherein the back-light unit 200 can include the light-source unit 210 having the light-source devices 212 and the color conversion sheet 230 disposed between the light-source devices 212 of the light-source unit 210 and the display panel 100, wherein the color conversion sheet 230 can include the first conversion substrate 231 on the light-source devices 212, the second conversion substrate 232 on the first conversion substrate 231, the conversion sheet layer 233 between the first conversion substrate 231 and the second conversion substrate 232, light-emitting bodies 234 and 235 dispersed within the conversion sheet layer 233, and the SBR patterns 236 disposed side by side on the lower surface of the second conversion substrate 232 toward the conversion sheet layer 233, and wherein the display panel 100 can be disposed on the upper surface of the second conversion substrate 232 opposite to the lower surface of the second conversion substrate 232. Thus, in the display apparatus according to the embodiment of the present disclosure, a ratio of short-wavelength blue light from the white light provided to the display panel 100 through the color conversion sheet 230 can be reduced. Therefore, in the display apparatus according to the embodiment of the present disclosure, harmfulness of the image provided to the user can be reduced.

And, in the display apparatus according to the embodiment of the present disclosure, short-wavelength blue light can be reflected inside the color conversion sheet 230 by each SBR pattern 236. Thus, in the display apparatus according to the embodiment of the present disclosure, the efficiency of the color conversion sheet 230 can be increased. Therefore, in the display apparatus according to the embodiment of the present disclosure, a decrease in the luminance of the white light provided to the display panel 100 due to the SBR patterns 236 can be prevented. That is, in the display apparatus according to the embodiment of the present disclosure, low-power operation can be possible, and power consumption can be reduced.

TABLE 2 is a table showing a ratio of short-wavelength blue light from the light passing through the color conversion sheet 230, the color gamut of the light passing through the color conversion sheet 230, and the relative luminance of the light passing through the color conversion sheet 230 according to an area occupied by the SBR patterns 236 with respect to the total area of the lower surface of the second conversion substrate 232. Here, a thickness of each SBR pattern 236 can be 750 nm.

TABLE 2

| An area of | Ratio of short- | Color | Relative |
|---|---|---|---|
| SBR patterns | wavelength blue | gamut | luminance |
| (%) | light (%) | (%) | (%) |
| 17.0 | 22.5 | 99.3 | 99.2 |
| 18.0 | 19.9 | 98.9 | 98.8 |
| 19.0 | 18.4 | 98.4 | 98.5 |
| 19.6 | 18.3 | 98.0 | 98.0 |
| 21.0 | 18.1 | 97.5 | 97.7 |
| 22.0 | 17.2 | 96.4 | 96.6 |
| 23.0 | 15.0 | 95.1 | 95.0 |

Referring to TABLE 2, in the display apparatus according to the embodiment of the present disclosure, if an area occupied by the SBR patterns 236 with respect to the total area of the lower surface of the second conversion substrate 232 is 19% to 21%, a ratio of short-wavelength blue light from the light passing through the color conversion sheet 230 cannot be significantly different. And, referring to TABLE 2, in the display apparatus according to the embodiment of the present disclosure, if an area occupied by the SBR patterns 236 with respect to the total area of the lower surface of the second conversion substrate 232 is 22% or more, the color gamut and the luminance of the light passing through the color conversion sheet 230 can be relatively significantly reduced. Thus, in the display apparatus according to the embodiment of the present disclosure, an area occupied by the SBR patterns 236 with respect to the total area of the lower surface of the second conversion substrate 232 can be 19% to 21%. Therefore, in the display apparatus according to the embodiment of the present disclosure, a decrease in the color gamut and the luminance of the white light provided to the display panel 100 due to the SBR patterns 236 can be minimized.

TABLE 3 is a table showing a ratio of short-wavelength blue light from the light passing through the color conversion sheet 230, the color gamut of the light passing through the color conversion sheet 230, and the relative luminance of the light passing through the color conversion sheet 230 according to a difference in a refractive index between the second conversion substrate 232 and each SBR pattern 236. Here, each of the SBR patterns 236 can have a thickness of 750 nm, an area occupied by the SBR patterns 236 can be 19% to 21% of the total area of the lower surface of the second conversion substrate 232. In TABLE 3, if a refractive index of the second conversion substrate 232 is greater than a refractive index of each SBR pattern 236, a difference in a refractive index can be expressed as a negative number.

TABLE 3

| | Ratio of short- | Color | Relative |
|---|---|---|---|
| Difference in a | wavelength blue | gamut | luminance |
| refractive index | light (%) | (%) | (%) |
| −0.5 | 50.3 | 99.1 | 100 |
| −0.25 | 30.1 | 99.0 | 99.2 |
| 0 | 18.8 | 98.2 | 98.7 |
| 0.27 | 18.3 | 98.0 | 98.0 |
| 0.5 | 18.2 | 98.0 | 97.9 |
| 0.75 | 18.1 | 98.1 | 97.9 |
| 1 | 18.1 | 97.9 | 98.0 |

Referring to TABLE 3, in the display apparatus according to the embodiment of the present disclosure, if a refractive index of each SBR pattern 236 is smaller than a refractive index of the second conversion substrate 232, a ratio of short-wavelength blue light from the light passing through the color conversion sheet 230 can be very large. Thus, in the display apparatus according to the embodiment of the present disclosure, a refractive index of each SBR pattern 236 can be equal to or less than a refractive index of the second conversion substrate 232.

Referring to TABLE 3, in the display apparatus according to the embodiment of the present disclosure, if a refractive index of each SBR pattern 236 is 0.27 or more greater than a refractive index of the second conversion substrate 232, a ratio of short-wavelength blue light from the light passing through the color conversion sheet 230 can be similar. Thus, in the display apparatus according to the embodiment of the present disclosure, a reflective index of each SBR pattern 236 can be 0.27 or more less than a refractive index of the second conversion substrate 232. Therefore, in the display apparatus according to the embodiment of the present disclosure, a decrease in the color gamut and the luminance of the light passing through the color conversion sheet 230 can be minimized, and a ratio of short-wavelength blue light from the light passing through the color conversion sheet 230 can be significantly reduced.

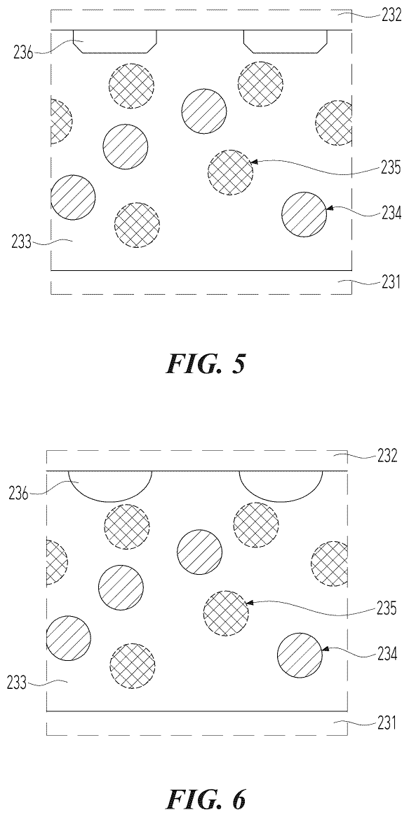

The display apparatus according to the embodiment of the present disclosure is described that each of the SBR patterns 236 has a constant thickness. However, in the display apparatus according to another embodiment of the present disclosure, a cross-section of each SBR pattern 236 can have various shapes. For example, in the display apparatus according to another embodiment of the present disclosure, a cross-section of each SBR pattern 236 can have a parallelogram or hexagonal shape, as shown in FIGS. 4 and 5. Thus, in the display apparatus according to another embodiment of the present disclosure, the degree of freedom in a cross-section shape of each SBR pattern 236 can be improved.

A shape of each SBR pattern 236 can affect a reflectance of short-wavelength blue light reflected by each SBR pattern 236. For example, in the display apparatus according to another embodiment of the present disclosure, the reflectance of short-wavelength blue light reflected by each SBR pattern 236 can be adjusted by a shape of each SBR pattern 236. Thus, in the display apparatus according to another embodiment of the present disclosure, the efficiency of the color conversion layer 230 can be affected by a shape of each SBR pattern 236. Each of the SBR patterns 236 can have a shape that increases the efficiency of the color conversion sheet 230. For example, in the display apparatus according to another embodiment of the present disclosure, a cross-section of each SBR pattern 236 can have a semicircular shape, as shown in FIG. 6. Each of the SBR patterns 236 can have a symmetrical shape. For example, each of the SBR patterns 236 can have a hemispherical shape. Therefore, in the display apparatus according to another embodiment of the present disclosure, a decrease in the luminance of the light passing through the color conversion sheet 230 due to each SBR pattern 236 can be minimized, and the efficiency of the color conversion sheet 230 can be maximized by the reflection of short-wavelength blue light.

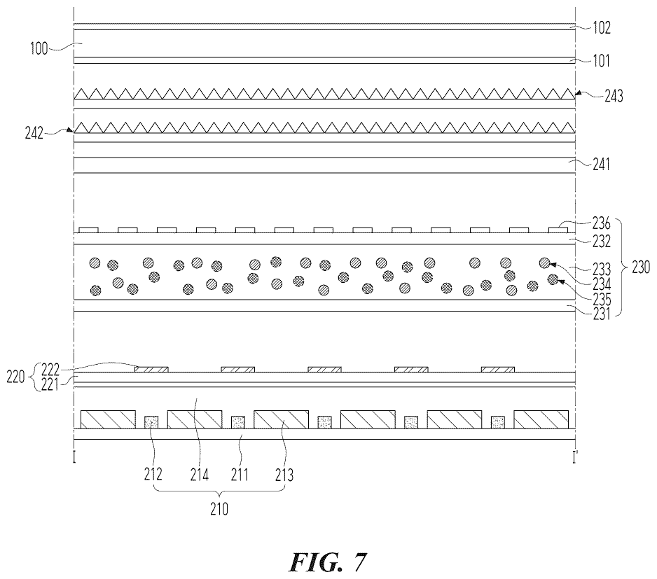

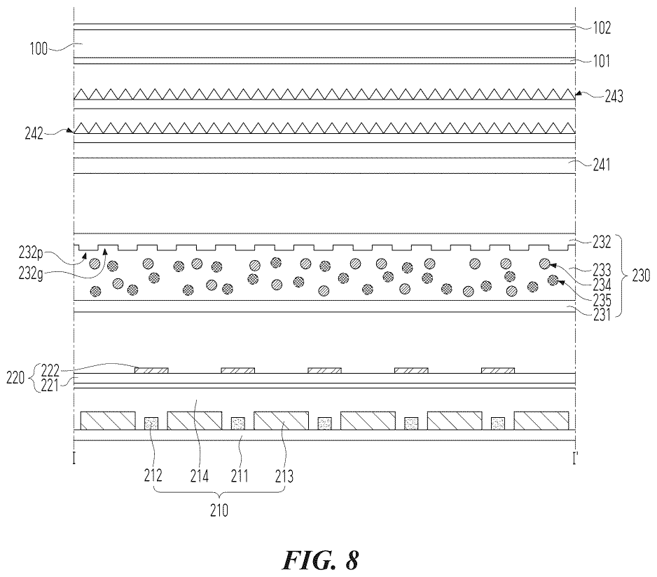

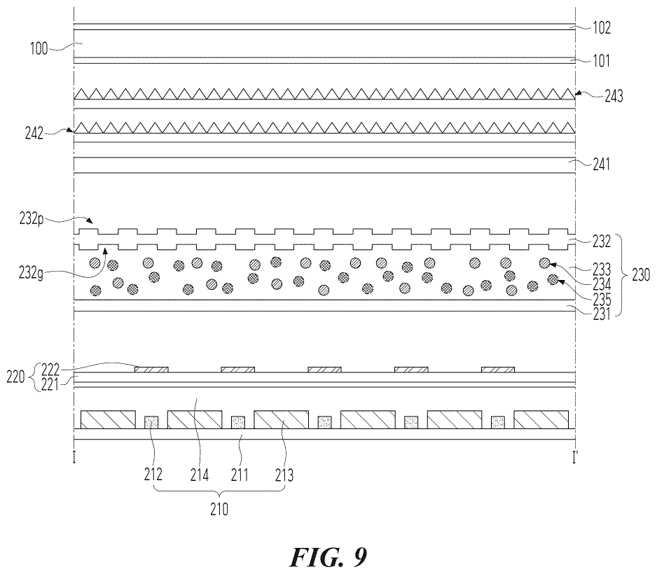

The display apparatus according to the embodiment of the present disclosure is described that the SBR patterns 236 are covered by the conversion sheet layer 233. However, in the display apparatus according to another embodiment of the present disclosure, the SBR patterns 236 can be spaced apart from the conversion sheet layer 233. For example, in the display apparatus according to another embodiment of the present disclosure, the SBR patterns 236 can be disposed side by side on the upper surface of the second conversion substrate 232 toward the display panel 100, as shown in FIG. 7. Thus, in the display apparatus according to another embodiment of the present disclosure, the damage of the light-emitting bodies 234 and 235 dispersed within the conversion sheet layer 233 due to the SBR patterns 236 can be prevented.

The display apparatus according to the embodiment of the present disclosure is described that the SBR patterns 236 include a different material from the second conversion substrate 232. However, in the display apparatus according to another embodiment of the present disclosure, the SBR patterns 236 can include a same material as the second conversion substrate 232. Thus, in the display apparatus according to another embodiment of the present disclosure, a boundary between each SBR pattern 236 and the second conversion substrate 232 can be recognized. For example, in the display apparatus according to another embodiment of the present disclosure, the lower surface of the second conversion substrate 232 toward the conversion sheet layer 230 can be recognized as having an uneven shape by concave regions 232g and convex regions 232p.

The convex regions 232p can function as the SBR pattern. For example, a different in a thickness between each concave region 232g and each convex region 232p can be 750 nm to 800 nm. Each of the concave regions 232g can have a larger size than each of the convex regions 232p. For example, in the display apparatus according to another embodiment of the present disclosure, an area ratio of the concave regions 232g and the convex regions 232p can be 81:19 to 79:21. Thus, in the display apparatus according to another embodiment of the present disclosure, a ratio of short-wavelength blue light from the white light provided to the display panel 100 can be reduced by the convex regions 232p. Therefore, in the display apparatus according to another embodiment of the present disclosure, a decrease in the color gamut and the luminance of the white light provided to the display panel 100 can be minimized, and the harmfulness of the image provided to the user can be reduced.

The convex regions 232p can be formed simultaneously with the concave region 232g. For example, in the display apparatus according to another embodiment of the present disclosure, the concave regions 232g and the convex region 232p can be formed by partially etching the lower surface of the second conversion substrate 232. Thus, in the display apparatus according to another embodiment of the present disclosure, a process of forming the concave regions 232g and the convex regions 232p can be simplified. Therefore, in the display apparatus according to another embodiment of the present disclosure, the production energy can be reduced by the process optimization.

In the display apparatus according to another embodiment of the present disclosure, the concave regions 232g and the convex regions 232p can be formed at the lower surface and the upper surface of the second conversion substrate 232. For example, in the display apparatus according to another embodiment of the present disclosure, an uneven shape of the upper surface of the second conversion substrate 232 by the concave regions 232g and the convex regions 232p can be symmetric to an uneven shape of the lower surface of the second conversion substrate 232 by the concave regions 232g and the convex regions 232p with respect to the center of the second conversion substrate 232. Thus, in the display apparatus according to another embodiment of the present disclosure, a ratio of short-wavelength blue light from the white light provided to the display panel 100 can be effectively reduced.

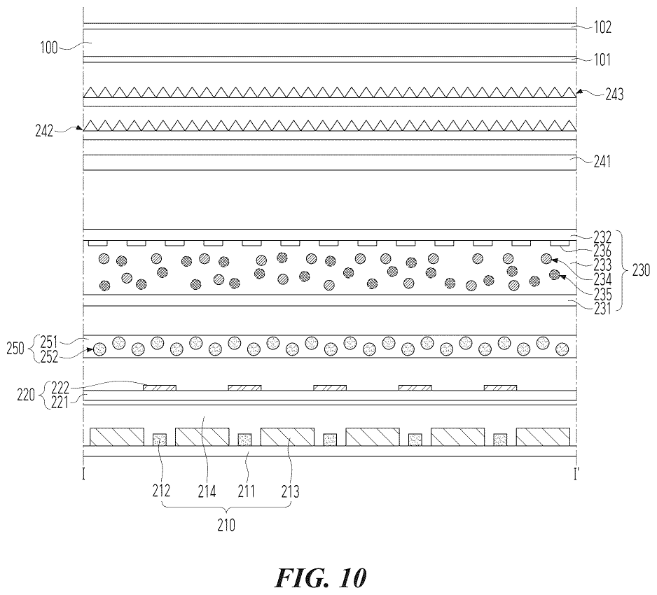

The display apparatus according to the embodiment of the present disclosure is described that the light passing through the light-blocking sheet 220 can be provided to the color conversion sheet 230. However, in the display apparatus according to another embodiment of the present disclosure, a layer for diffusing blue light can be disposed between the light-blocking sheet 220 and the color conversion sheet 230. For example, in the display apparatus according to another embodiment of the present disclosure, a blue emission sheet 250 including blue light-emitting bodies 252 can be disposed between the light-blocking sheet 220 and the color conversion sheet 230, as shown in FIG. 10.

The blue emission sheet 250 can include an emission sheet layer 251. The emission sheet layer 251 can include a material having a high transmittance. For example, the emission sheet layer 251 can include a transparent resin. The emission sheet layer 251 can be disposed parallel to the light-blocking substrate 221. The blue light-emitting bodies 252 can be dispersed within the emission sheet layer 251. For example, each of the blue light-emitting bodies 252 can be surrounded by the emission sheet layer 251.

Each of the blue light-emitting bodies 252 can emit blue light in all direction using the blue light passing through the light-blocking sheet 220. That is, in the display apparatus according to another embodiment of the present disclosure, the blue light emitted toward the display panel 100 from each light-source device 212 can be diffused in all direction by one of the blue light-emitting bodies 252. Thus, in the display apparatus according to another embodiment of the present disclosure, the red light by each red light-emitting body 234, the green light by each green light-emitting body 235, and the blue light by each blue light-emitting body 252 can have a same travelling direction. Therefore, in the display apparatus according to another embodiment of the present disclosure, occurrence of spots due to difference in the luminance according to the azimuth of the white light formed by mixing the red light by each red light-emitting body 234, the green light by each green light-emitting body 235, and the blue light by each blue light-emitting body 252 can be prevented.

In the result, the display apparatus according to the embodiments of the present disclosure can comprise the back-light unit providing the light to the display panel, wherein the back-light unit can include the light-source unit having the light-source devices and the color conversion sheet between the light-source devices and the display panel, and wherein the color conversion sheet can include the conversion sheet layer disposed between the first conversion substrate and the second conversion substrate, the light-emitting bodies dispersed within the conversion sheet layer, and the SBR patterns disposed side by side on at least one surface of the second conversion substrate. Thus, in the display apparatus according to the embodiments of the present disclosure, a ratio of short-wavelength blue light from the light provided to the display panel through the color conversion sheet can be reduced. Thereby, in the display apparatus according to the embodiments of the present disclosure, the harmfulness of the image provided to the user can be reduced. And, in the display apparatus according to the embodiments of the present disclosure, the efficiency of the color conversion sheet can be improved. That is, in the display apparatus according to the embodiments of the present disclosure, low-power operation can be possible, and power consumption can be reduced.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus, comprising:
a light-source unit including light-source devices;
a display panel on the light-source devices of the light-source unit; and
a color conversion sheet between the light-source devices and the display panel, the color conversion sheet including a first conversion substrate, a second conversion substrate, a conversion sheet layer, light-emitting bodies, and SBR patterns,
wherein the light-emitting bodies are dispersed within the conversion sheet layer disposed between the first conversion substrate and the second conversion substrate,
wherein the second conversion substrate includes a lower surface toward the conversion sheet layer and an upper surface toward the display panel, and
wherein the SBR patterns are disposed side by side on at least one of the lower surface and the upper surface of the second conversion substrate.

2. The display apparatus according to claim 1, wherein a thickness of each of the SBR patterns is 750 nm to 800 nm.

3. The display apparatus according to claim 1, wherein the SBR patterns are in direct contact with the second conversion substrate.

4. The display apparatus according to claim 3, wherein the SBR patterns being in contact with the second conversion substrate are surrounded by the conversion sheet layer.

5. The display apparatus according to claim 3, wherein the SBR patterns include a different material from the second conversion substrate.

6. The display apparatus according to claim 5, wherein a refractive index of each of the SBR patterns is greater by at least 0.27 than a refractive index of the second conversion substrate.

7. The display apparatus according to claim 1, wherein a width of each of the SBR patterns is smaller than a distance between adjacent SBR patterns.

8. The display apparatus according to claim 7, wherein an area occupied by the SBR patterns is 19% to 21% of the total area of the lower surface or the upper surface of the second conversion substrate.

9. The display apparatus according to claim 1, wherein each of the light-source devices emits blue light toward the display panel, and
wherein the light-emitting bodies include red light-emitting bodies emitting red light in all directions using blue light and green light-emitting bodies emitting green light in all direction using blue light.

10. The display apparatus according to claim 9, further comprising blue light-emitting bodies between the light-source devices and the color conversion sheet,
wherein blue light emitted from each light-source device is diffused in all directions by one of the blue light-emitting bodies.

11. A display apparatus, comprising:
a light-source unit including light-source devices;
a color conversion sheet on the light-source devices; and
a display panel on the color conversion sheet,
wherein the color conversion sheet includes a conversion sheet layer between a first conversion substrate and a second conversion substrate,
wherein the second conversion substrate includes a lower surface toward the conversion sheet layer and an upper surface toward the display panel, and
wherein at least one of the lower surface and the upper surface of the second conversion substrate has an uneven shape by concave regions and convex regions.

12. The display apparatus according to claim 11, wherein a thickness difference between each concave region and each convex region is 750 nm to 800 nm.

13. The display apparatus according to claim 11, wherein a thickness of each convex region is smaller than a thickness of each concave region.

14. The display apparatus according to claim 13, wherein an area ratio of the concave regions to the convex regions is from 81:19 to 79:21.

15. The display apparatus according to claim 11, wherein each of the upper surface and the lower surface of the second conversion substrate has an uneven shape.

16. The display apparatus according to claim 15, wherein an uneven shape of the upper surface is symmetric to an uneven shape of the lower surface with respect to the center of the second conversion substrate.
